(19) United States
(12) Patent Application Publication
(10) Pub. No.: US 2008/0098864 A1
(43) Pub. Date: May 1, 2008

(54) Lathe having multirail

(76) Inventor: Yuan Tang Kao, Taichung Hsien (TW)

Correspondence Address: CHARLES E. BAXLEY, ESQ., 90 JOHN STREET, THIRD FLOOR, NEW YORK, NY, 10038, US

(21) Appl. No.: 11/590,692

(22) Filed: Oct. 31, 2006

(51) Int. Cl. B23B 7/00

(52) U.S. Cl. 82/118

(57) ABSTRACT

A lathe includes a supporting base having a rear rail, an intermediate rail, and a front rail and a rotatable threaded shank, a headstock supported on the supporting base and having a chuck for holding a work piece, a tailstock slidably engaged onto the rear rail and having a center for being moved to engage with the work piece, a carriage slidably engaged onto the intermediate rail and the front rail, and a slide slidably attached onto the carriage and having a cutting member for being moved to machine the work piece. The tailstock is slidably engaged onto the rear rail and the carriage is slidably engaged onto the intermediate rail and the front rail such that the movement of the tailstock and the carriage will not be interfered with each other.

### BACKGROUND OF THE INVENTION

1. Field of the Invention

The present invention relates to a cutting machine or a machine tool or a lathe, and more particularly to a lathe including a number of rails for slidably supporting a tailstock and a carriage and for preventing the movements of the tailstock and the carriage from being interfered with each other.

2. Description of the Prior Art

Typical cutting machines or machine tools or lathes or the like comprise a headstock including a chuck device for grasping and holding a work piece, a tailstock for attaching or supporting a quill and/or a center and for moving the center toward and to engage with the work piece, and a carriage for supporting a cutting member and for moving the cutting member to machine or to cut or to work on the work piece.

For example, U.S. Pat. No. 4,018,113 to Blazenin et al. discloses one of the typical machine tools also comprising a spindle-head with a horizontal main spindle supported therein, a support mounted on a cross-slide for supporting a tool holder, and a hollow holder attached to a casing with a vertical rod.

However, the typical machine tools comprise only one rail for slidably attaching or supporting the cross-slide, but failed to provide the other rails for slidably attaching or supporting the carriages or the work pieces such that the movements of the cross-slide and the carriage may be interfered with each other.

U.S. Pat. No. 4,324,161 to Klancnik et al. discloses another typical machine tool or lathe comprising a spindle housing for holding or supporting a spindle, a tailstock or turret supported for rotary indexing movement on a head of a slide, and a cross slide positioned between the headstock and the tailstock for carrying a front and back tool.

However, the cross slide or the turret supporting head or slide are slidably supported on the same rail such that the movement of the cross slide or the turret supporting head or slide will be interfered with each other.

The present invention has arisen to mitigate and/or obviate the afore-described disadvantages of the conventional lathes.

### SUMMARY OF THE INVENTION

The primary objective of the present invention is to provide a lathe including a number of rails for slidably supporting a tailstock and a carriage and for preventing the movements of the tailstock and the carriage from being interfered with each other.

In accordance with one aspect of the invention, there is provided a lathe comprising a supporting base including a rear rail, an intermediate rail, and a front rail provided on an upper portion of the supporting base and parallel to each other, and including a threaded shank rotatably disposed in the supporting base and located between the intermediate rail and the front rail and parallel to the intermediate rail and the front rail, a headstock supported on one side of the supporting base and including a chuck device provided thereon for grasping and holding a work piece to be machined, a tailstock slidably engaged onto the rear rail and including a center provided thereon for being moved toward the chuck device in order to engage with and to retain the work piece between the headstock and the tailstock, a carriage slidably engaged onto the intermediate rail and the front rail and movable along the intermediate rail and the front rail, and a slide slidably attached onto the carriage and including a cutting member engaged onto the slide for allowing the cutting member to be moved toward the work piece in order to machine the work piece by the carriage and the slide, the tailstock is slidably engaged onto the rear rail and the carriage is slidably engaged onto the intermediate rail and the front rail for preventing the tailstock and the carriage from being interfered with each other.

The supporting base includes an upper cut off portion or an inclined surface provided on the upper portion of the supporting base, and the front rail is provided on the inclined surface of the supporting base. The front rail is preferably arranged lower than the intermediate rail.

The supporting base includes a shoulder provided in such as the lower portion of each of the intermediate rail and the front rail, and the carriage includes two retainers attached thereto for stably engaging with the shoulders of the supporting base and for preventing the carriage from being overturned from the supporting base.

The carriage includes two slots for slidably engaging with the intermediate rail and the front rail respectively, and it is preferable that the retainers are partially extended into the slots of the carriage for stably engaging with the intermediate rail and the front rail respectively.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front plan schematic view of a lathe in accordance with the present invention;

FIG. 2 is a top plan schematic view of the lathe;

FIG. 3 is a side plan schematic view of the lathe, in which a portion of the lathe has been cut off for showing an inner structure of the lathe;

FIG. 4 is an enlarged partial side plan schematic view of the lathe; and

FIG. 5 is a rear perspective view illustrating a supporting base for the lathe.

### DETAILED DESCRIPTION OF THE PREFERRED EMBODIMENT

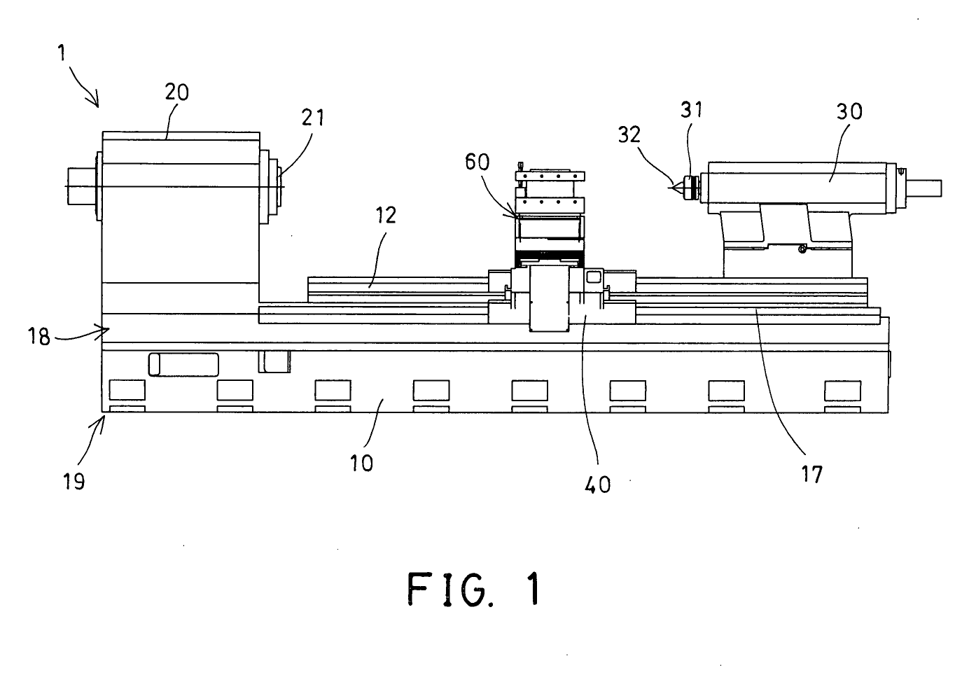

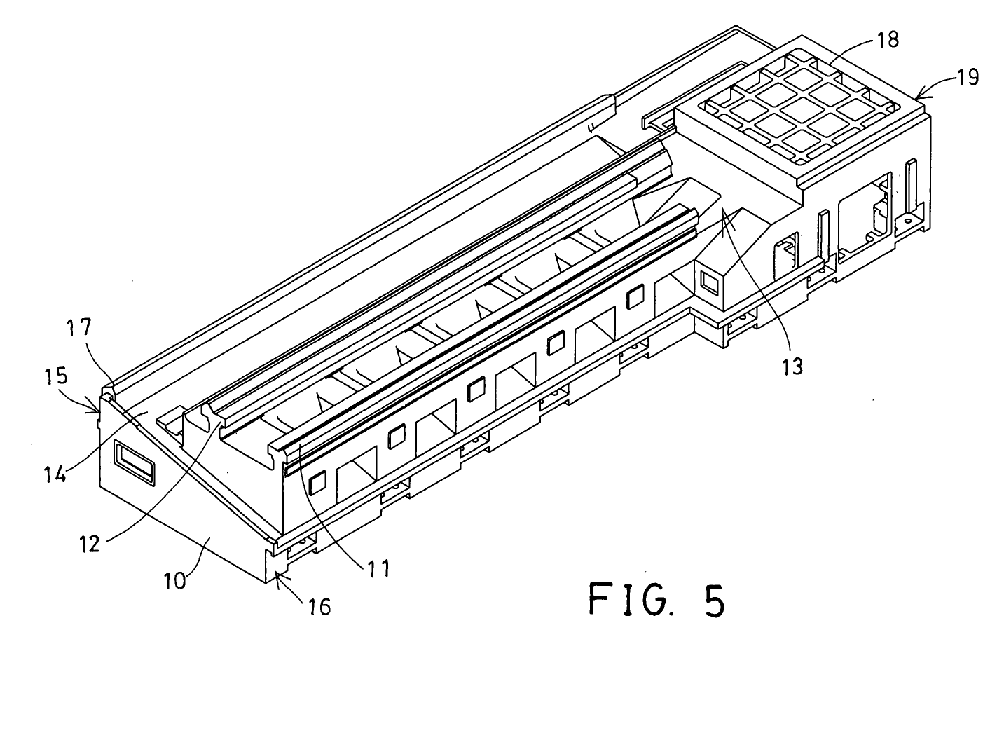

Referring to the drawings, and initially to FIGS. 1-3 and 5, a lathe 1 in accordance with the present invention comprises a supporting base 10 including a first or rear rail 11 and a second or intermediate rail 12 formed or provided on the upper portion 13 thereof and parallel to each other, and including a cut off portion or recess or an inclined surface 14 formed or provided on the upper portion 13 thereof and inclined from the front portion 15 toward the rear portion 16 of the supporting base 10, and including a third or front rail 17 also formed or provided on the upper portion 13 or on the inclined surface 14 of the supporting base 10 and parallel to the first or rear rail 11 and the second or intermediate rail 12. It is preferable that the third or front rail 17 is arranged lower than the first or rear rail 11 and/or the second or intermediate rail 12 or includes a height smaller or lower than the first or rear rail 11 and/or the second or intermediate rail 12.

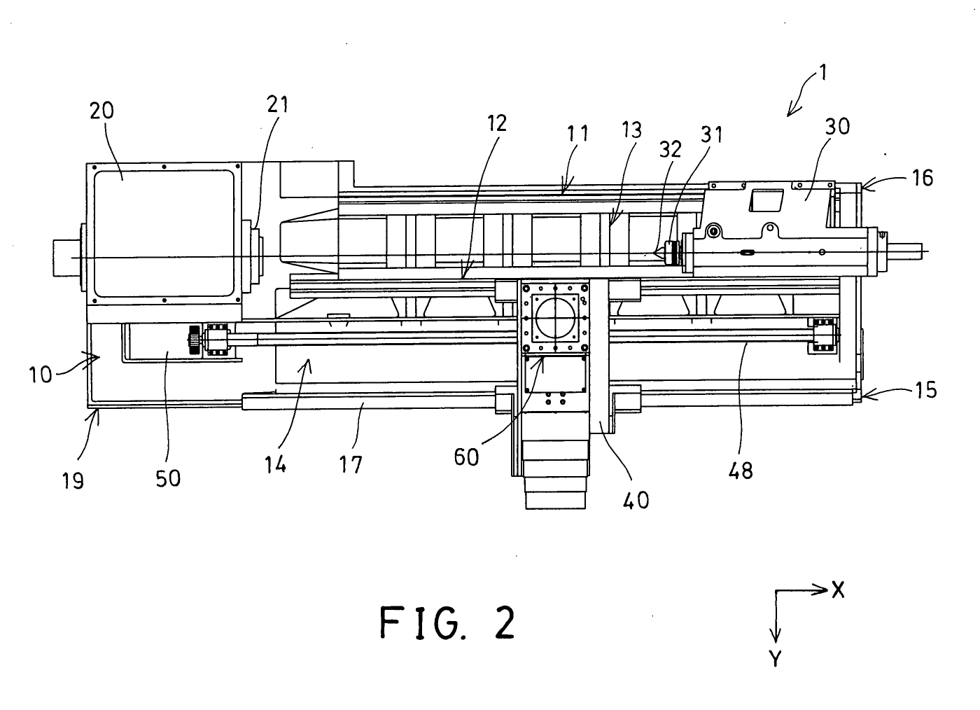

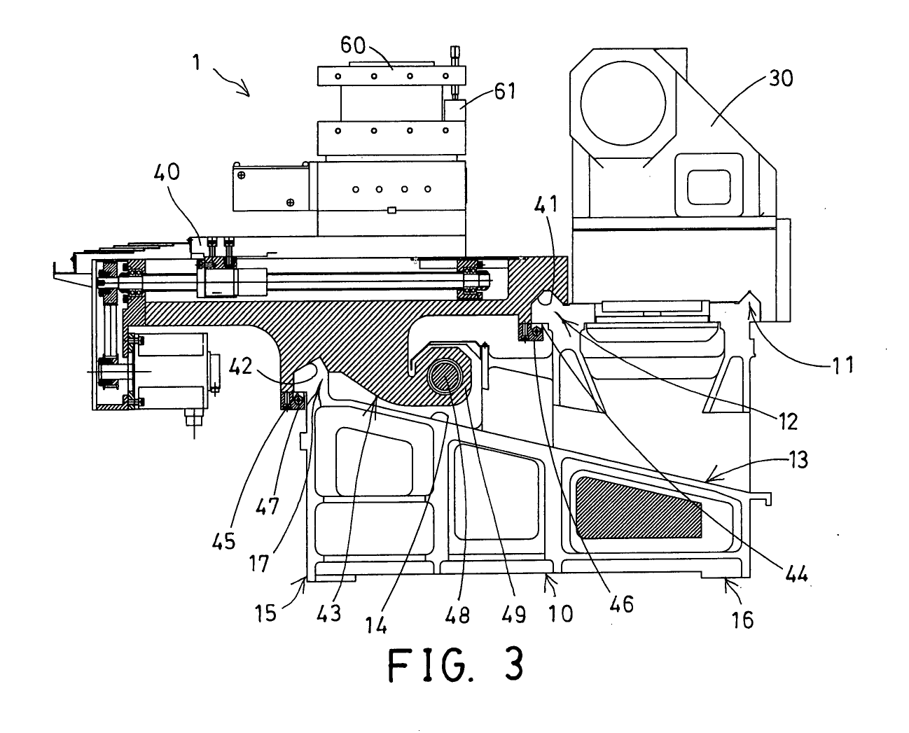

The supporting base 10 may further include a seat or platform 18 formed or provided on one side portion or left side portion 19 of the supporting base 10 for attaching or supporting a headstock 20 in which the headstock 20 includes a typical chuck device 21 provided thereon for grasping and holding a work piece to be machined or cut or worked by the lathe 1. A tailstock 30 is slidably attached or engaged onto the first or rear rail 11 (FIGS. 2, 3) and movable along an X-axis or direction and includes a quill 31 with a center 32 (FIGS. 1, 2) which may be moved toward the chuck device 21 and the work piece in order to engage the center 32 with the work piece and to retain or support the work piece on the supporting base 10 and to position the work piece between the headstock 20 and the tailstock 30.

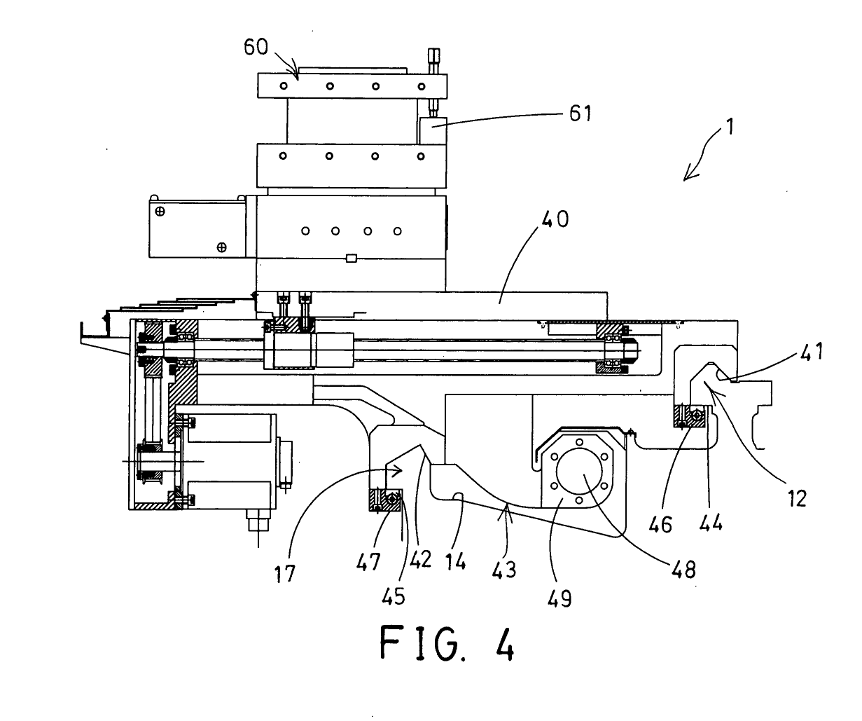

A carriage 40 is slidably attached or engaged onto the second or intermediate rail 12 and the third or front rail 17 (FIGS. 2-4) and includes two slots 41, 42 formed in the bottom portion 43 thereof for slidably engaging with the second or intermediate rail 12 and the third or front rail 17 respectively for allowing the carriage 40 to be moved along the second or intermediate rail 12 and the third or front rail 17 and also movable along the X-axis or direction. The supporting base 10 may further include a lower shoulder 44, 45 formed or provided in the lower portion of each of the second or intermediate rail 12 and the third or front rail 17, and the carriage 40 includes two retainers 46, 47 attached to the bottom portion 43 thereof and partially extended into the slots 41, 42 thereof for stably engaging with the shoulders 44, 45 of the supporting base 10 and the second or intermediate rail 12 and the third or front rail 17 respectively and for preventing the carriage 40 from been tilted or overturned from the supporting base 10.

The supporting base 10 further includes a bolt or threaded shank 48 rotatably disposed or supported therein and preferably arranged or located between and parallel to the second or intermediate rail 12 and the third or front rail 17 (FIGS. 2-4), and the carriage 40 includes a corresponding threaded block 49 provided or attached to the bottom portion 43 thereof for threading or engaging with the bolt or threaded shank 48. A driving device or driving motor 50 (FIG. 2) may further be coupled to the bolt or threaded shank 48 for driving or rotating the bolt or threaded shank 48 and for moving the carriage 40 along the X-axis or direction and along the second or intermediate rail 12 and the third or front rail 17.

The carriage 40 further includes a slide 60 slidably attached or engaged onto the carriage 40 and movable along a Y-axis or direction (FIG. 2), and includes a cutting member or device 61 attached or engaged onto the slide 60 for allowing the cutting member 61 to be moved toward the work piece in order to machine or to cut or to work on the work piece. It is to be noted that the tailstock 30 is slidably attached or engaged onto the first or rear rail 11 and the carriage 40 is slidably attached or engaged onto the second or intermediate rail 12 and the third or front rail 17 such that the movements of the tailstock 30 and the carriage 40 will not be interfered with each other and such that the center 32 may be effectively moved to engage with the work piece and to retain or support the work piece on the supporting base 10, and the cutting member 61 may be effectively moved to engage with the work piece and to work on the work piece.

Accordingly, the lathe in accordance with the present invention includes a number of rails for slidably supporting a tailstock and a carriage and for preventing the movements of the tailstock and the carriage from being interfered with each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A lathe comprising:
a supporting base including a rear rail, an intermediate rail, and a front rail provided on an upper portion of said supporting base and parallel to each other, and including a threaded shank rotatably disposed in said supporting base and located between said intermediate rail and said front rail and parallel to said intermediate rail and said front rail,
a headstock supported on one side of said supporting base and including a chuck device provided thereon for grasping and holding a work piece to be machined,
a tailstock slidably engaged onto said rear rail and including a center provided thereon for being moved toward said chuck device in order to engage with and to retain the work piece between said headstock and said tailstock,
a carriage slidably engaged onto said intermediate rail and said front rail and movable along said intermediate rail and said front rail, and
a slide slidably attached onto said carriage and including a cutting member engaged onto said slide for allowing said cutting member to be moved toward the work piece in order to machine the work piece by said carriage and said slide,
said tailstock being slidably engaged onto said rear rail and said carriage being slidably engaged onto said intermediate rail and said front rail for preventing said tailstock and said carriage from being interfered with each other.

2. The lathe as claimed in claim 1, wherein said supporting base includes an inclined surface provided on said upper portion of said supporting base, and said front rail is provided on said inclined surface of said supporting base.

3. The lathe as claimed in claim 1, wherein said front rail is arranged lower than said intermediate rail.

4. The lathe as claimed in claim 1, wherein said supporting base includes a shoulder provided in each of said intermediate rail and said front rail, and said carriage includes two retainers attached thereto for stably engaging with said shoulders of said supporting base and for preventing said carriage from being overturned from said supporting base.

5. The lathe as claimed in claim 4, wherein said carriage includes two slots for slidably engaging with said intermediate rail and said front rail respectively, said retainers are partially extended into said slots of said carriage.
